(19) United States
(12) Patent Application Publication
(10) Pub. No.: US 2020/0151658 A1
(43) Pub. Date: May 14, 2020

(54) FLIGHT CHECKED BAGGAGE TRANSACTION SYSTEM AND APPLICATION USING SAME

(71) Applicant: Jeong-Yeup LEE, Seoul (KR)

(72) Inventor: Jeong-Yeup LEE, Seoul (KR)

(21) Appl. No.: 16/742,343

(22) Filed: Jan. 14, 2020

Related U.S. Application Data
(63) Continuation of application No. PCT/KR2017/013992, filed on Dec. 1, 2017.

(30) Foreign Application Priority Data
Jul. 21, 2017 (KR) 10-2017-0092781
Oct. 31, 2017 (KR) 10-2017-0143368

(51) Int. Cl. G06Q 10/08; G06Q 30/02

(52) U.S. Cl. CPC G06Q 10/0831; G06Q 30/0207

(57) ABSTRACT

The aim of the present invention is to provide a checked baggage transaction system and transaction method wherein, by carrying out a transaction using a surplus amount or number of pieces of checked baggage or points corresponding thereto, a seller can obtain a plane ticket discount, and a purchaser can purchase a required of excessive surplus amount or number of pieces of checked baggage, or points corresponding thereto at a lower price.

### CROSS-REFERENCE TO RELATED APPLICATIONS

This application is a Continuation of International Application No. PCT/KR2017/013992 filed on Dec. 1, 2017, which claims benefit of priority to Korean Patent Application No. 10-2017-0143368 filed on Oct. 31, 2017 and Korean Patent Application No. 10-2017-0092781 filed on Jul. 21, 2017, the entire content of which is incorporated herein by reference.

### TECHNICAL FIELD

The present invention relates to a flight checked baggage transaction system and a transaction method.

### BACKGROUND ART

In general, air freight and airfare mean a comprehensive amount charged by airlines to air traffic users in exchange for the carriage of passengers and baggage.

According to an international flight, the airfare and fares may be charged by the airline to the passengers, as determined by an Air Services Agreement concluded between countries.

Therefore, the baggage allowance that may be carried and checked by the individual is provided for free at the time of boarding the aircraft, and such baggage allowance is included in the airfare already paid by the passenger.

Free baggage allowance and excess charges may vary for each airline, flight segment, seat class, and airline membership class, and certain baggage capacity or quantity or points corresponding thereto are given to passengers.

Referring to FIG. 1, as seen from the official English name of the ticket that is termed “Passenger Ticket and Baggage Check”, the ticket relates to passenger ticket and baggage check.

Since ticket holders can send only a limited baggage allowance and the aircraft has a weight-sensitive nature unlike other transportation means, personal baggage (luggage, cargo) on board aircraft is of interest.

Checked baggage in excess of free baggage allowance may incur additional charges depending on the excess baggage capacity or quantity or points corresponding thereto. Some passengers have faced difficult situations at airports due to the additional costs incurred since they fail to check checked baggage regulation.

### DISCLOSURE

### Technical Problem

In order to solve the problem as described above, an objective of the present invention is to provide a checked baggage transaction system and a transaction method, by which the seller can obtain a ticket discount effect, and the purchaser can purchase the flight checked baggage capacity or quantity of an excess weight or a required weight or points corresponding thereto at a lower cost, by trading the excess capacity or quantity of the flight checked baggage or points corresponding thereto.

### Technical Solution

In order to achieve the above object, the present invention provides a flight checked baggage transaction system, including: on the basis of a ticket for which a flight checked baggage is allowed up to a first weight, a first terminal registering sale information for selling a flight checked baggage capacity or quantity of a second weight or points corresponding thereto less than the first weight; on the basis of a ticket for which a flight checked baggage is allowed up to a third weight, a second terminal registering purchase information for purchasing a flight checked baggage capacity or quantity of a weight exceeding the third weight or a required weight or points corresponding thereto; and a transaction server in which the sale information and the purchase information are registered.

In addition, the present invention provides a transaction method of flight checked baggage, the method including: at a transaction server in which sale information and purchase information are registered, on the basis of a ticket for which a flight checked baggage is allowed up to a first weight, registering the sale information for selling a flight checked baggage capacity or quantity of a second weight less than the first weight or points corresponding thereto through a first terminal; and on the basis of the tickets for which a flight checked baggage is allowed up to a third weight, registering the purchase information for purchasing a flight checked baggage capacity or quantity or points corresponding thereto of a weight exceeding the third weight or a required weight through a second terminal.

### Advantageous Effects

According to the present invention, there are advantages that the seller can obtain a ticket discount effect, and the purchaser can purchase the flight checked baggage capacity or quantity of an excess weight or a required weight or points corresponding thereto at a lower cost.

### DESCRIPTION OF DRAWINGS

FIG. 1 is a diagram illustrating an exemplary air ticket.

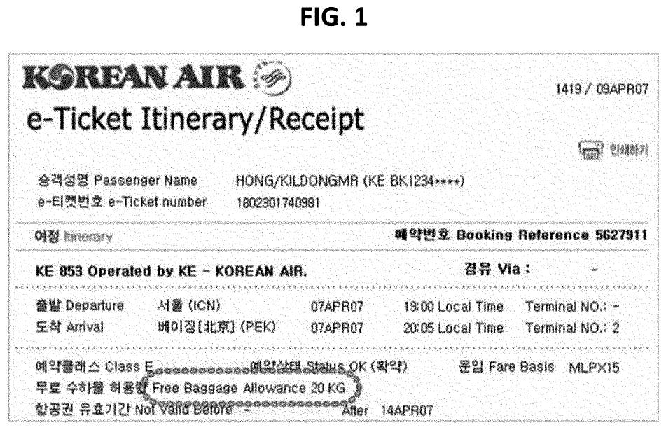

FIGS. 2 and 3 are schematic diagrams illustrating a flight checked baggage transaction system according to an embodiment of the present invention.

FIG. 4 is a diagram illustrating a transaction server according to an embodiment of the present invention.

### MODE FOR INVENTION

Hereinafter, exemplary embodiments of the present invention will be described in detail with reference to the accompanying drawings. Prior to this, terms or words used in the present specification and claims should not be construed as being limited to the common or dictionary meanings, and the inventor should interpret the meaning and concept corresponding to the technical idea of the present invention on the basis of the principle that the concept of the term can be properly defined in order to explain the invention in the best way.

In addition, irrespective of the reference numerals, the same or corresponding components will be given the same or similar reference numerals, and redundant description thereof will be omitted. For convenience of description, the size and shape of each component member may be exaggerated or reduced.

Therefore, the embodiments described in the specification and the drawings shown in the drawings are only the most preferred embodiment of the present invention and do not represent all of the technical ideas of the present invention. Accordingly, it should be understood that there may be equivalents and variations that can be replaced at the time of the present application

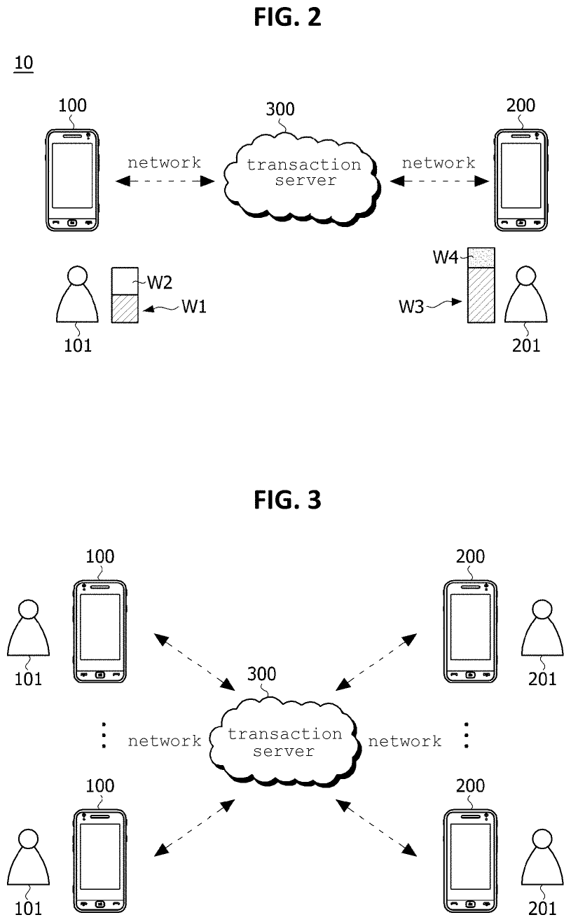

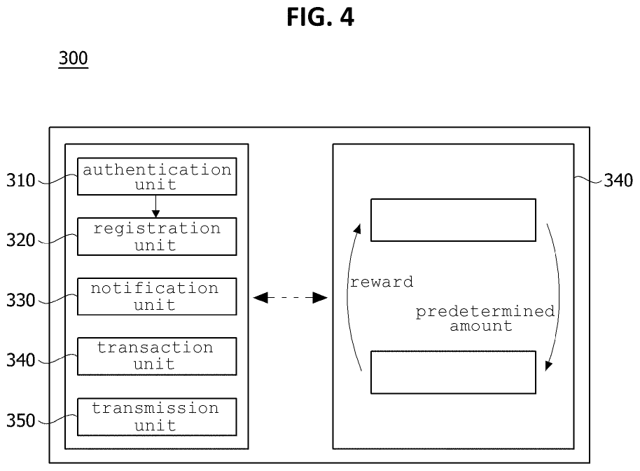

FIGS. 2 and 3 are schematic diagrams illustrating a flight checked baggage transaction system according to an embodiment of the present invention; and FIG. 4 is a diagram illustrating a transaction server according to an embodiment of the present invention.

Hereinafter, with reference to FIGS. 2 to 4, a flight checked baggage transaction system and a transaction method according to an embodiment of the present invention will be described in detail.

First, in the present specification, the term “terminal” means a device such as a mobile phone, a computer, a laptop, and the like, by which a user may connect to an Internet server or the like through a wired or wireless communication network.

In addition, the term “server” refers to software for providing a certain service to each terminal connected to a server through a communication network.

The present invention relates to a flight checked baggage transaction system and a transaction method using the same.

The flight checked baggage transaction system 10 according to an embodiment of the present invention includes a first terminal 100, a second terminal 200, and a transaction server 300.

More specifically, referring to FIG. 2, on the basis of a ticket for which a flight checked baggage is allowed up to a first weight W1, the first terminal 100 is provided to register sale information for selling a flight checked baggage capacity or quantity of a second weight W2 less than the first weight or points corresponding thereto.

In addition, on the basis of a ticket for which a flight checked baggage is allowed up to a third weight W3, the second terminal 200 is provided to register purchase information for purchasing a flight checked baggage capacity or quantity of a weight exceeding the third weight W3 or a required weight W4 or points corresponding thereto.

In addition, the transaction server 300 may be provided so that the sale information and purchase information may be registered.

Here, the first terminal 100 includes a seller 101 that accesses the transaction server 300 through the first terminal 100 and registers the sale information.

Further, the second terminal 200 includes a purchaser 201 that accesses the transaction server 300 through the second terminal 200 and registers purchase information.

In addition, the transaction server 300 may be at least one specific airline or a server associated with the airline, but is not limited thereto.

In addition, referring to FIG. 3, there are multiple sellers 101 using a specific flight, and accordingly, multiple first terminals 100 may be provided.

In addition, there are multiple purchasers 201 using a specific flight, and accordingly, multiple second terminals 200 may be provided.

In particular, the ticket of the seller 101 and the purchaser 201 means the case where a flight, departure, moving section, boarding date, and boarding time is the same.

Meanwhile, each of the first weight W1 and the third weight W3 is a maximum flight checked baggage allowance related to a take-off and landing weight and an allowed cabin load (ACL) or points corresponding thereto for each corresponding aircraft.

That is, it may mean the maximum flight checked baggage allowance and points corresponding thereto included in each ticket.

Here, the weight may mean a capacity (Kg) or a quantity (the number of pieces), or points corresponding to the capacity or quantity.

That is, the first weight and the third weight may be, for example, 30 Kg or two bags, or points corresponding thereto.

The ticket may vary in weight or quantity of a flight checked baggage included in the ticket according to a seat class of the ticket, a member class of the airline, and the like.

As an example, in the case of the same membership class, First Class ticket has 32 kg and three bags, that is, 96 kg as the maximum flight checked baggage allowance; and Economy Class tickets has 23 kg and two bags, that is, 46 kg as the maximum flight checked baggage allowance.

Therefore, since the first weight W1 and the third weight W3 is the maximum flight checked baggage allowance included in the ticket, the first weight W1 and the third weight W3 may be the same in the case of the ticket of the same membership class and seat class.

Meanwhile, when the membership classes are the same to each other but seat classes are different ticket from each other, the first weight W1 and the third weight W3 may be different from each other

That is, the first weight W1 and the third weight W3 may be the same or different, and the third weight W3 is larger or smaller than the first weight W1

Meanwhile, the second weight W2 may be the remaining weight or quantity or points corresponding thereto, which is obtained by subtracting the flight checked baggage capacity or quantity to be used by the seller or points corresponding thereto from the first weight W1.

As an example, when the first weight W1 is 20 kg, the flight checked baggage capacity to be used by the seller is 10 kg, the remaining weight may be 10 kg.

That is, the flight checked baggage of the second weight W2 to be sold by the seller may be 10 kg.

As another example, in the case that the first weight W1 means the quantity, when the quantity corresponding to the first weight is two, and the quantity of checked baggage to be used by the seller is one, the remaining quantity may be one. That is, the remaining quantity may be one.

In particular, the second weight W2 may mean points corresponding to the remaining weight and quantity.

Thus, the second weight W2 may mean the excess weight or quantity or the corresponding point thereto that the seller has used and left from the flight checked baggage allowance.

In the following, capacity are described as an example, but it should be understood that each of the first weight to third weight of the present specification may mean quantity and points corresponding thereto as described above.

In addition, the transaction server 300 may include an authentication unit 310 that is provided to authenticate the ticket before registering the sale and purchase information.

The authentication unit 310 may include information authentication for seller or purchaser.

That is, before registering the sale and purchase information, it is possible to make flight checked baggage transaction more accurate by authenticating the ticket including the information of the seller or purchaser.

Meanwhile, the transaction server 300 may include a registration unit 320 for registering sales and purchase information.

That is, the seller 101 and the purchaser 201 may register sale information or purchase information at the registration unit 320 after the ticket authentication.

In addition, the ticket includes a departure time and a departure time, and the seller 101 may register the flight checked baggage capacity or quantity of the second weight W2 and points corresponding thereto at the transaction terminal 300 through the first terminal 100 at least before check-in or boarding.

In addition, the purchaser 201 may purchase, as a predetermined reward, at least some of the flight checked baggage capacity or quantity of the second weight W2 or points corresponding thereto registered at the transaction server 300 via the second terminal 200.

Herein, the seller 101 who registers the flight checked baggage capacity or quantity of the second weight (W2) or points corresponding thereto, may receive the predetermined reward from the purchaser 201 through the transaction server 300 or a separate payment and settlement system.

Here, the reward may be any one selected from cash, securities, and virtual currency.

More specifically, the securities may include, but is not limited to, other securities such as ticket discount coupons, air mileage, gift certificates, points, and virtual currency.

In addition, the separate payment and settlement system may include, but is not limited to, direct deposit, card payment, telephone payment, point payment, and the like.

Meanwhile, all or at least some of the flight checked baggage capacity or quantity of the second weight (W2) registered at the transaction server 300 or points corresponding thereto may be sold by an auction method.

In addition, when the sale information is registered at the transaction server 300, the transaction server is provided to purchase a flight checked baggage capacity or quantity of the second weight W2 or points corresponding thereto through the multiple second terminals 200 in an auction method.

On the contrary, when the purchase information is registered at the transaction server 300, the transaction server is provided to buy a flight checked baggage capacity or quantity of a weight exceeding the third weight W3 or a required weight or points corresponding thereto through the multiple first terminals 100 in an auction method.

In addition, the transaction server 300 may include a notification unit 330 that is provided to inform the seller 101 or the purchaser 201 of registered sale or purchase information, when the sale information or the purchase information is registered at the transaction server 300 through the first or second terminal 100 or 200,

More specifically, when the seller or purchaser authenticates the ticket at the transaction server 300 through the authentication unit 310, the sale or purchase information registered at the transaction server 300 through the registration unit 320 may be transmitted by the notification unit 330 to the first and second terminals 100 and 200.

Therefore, the purchaser or seller buys or sells the flight checked baggage capacity or quantity or points corresponding thereto via the transmitted notification, whereby there is an effect that the transaction is made easier.

In addition, when the sale information or the purchase information is registered through the first or second terminal 100 or 200, and the transaction related to the sale information or the purchase information is completed, the transaction server 300 may be provided to notify the airline of transaction information thereof.

In addition, when the sale information or purchase information is registered through the first or second terminal 100 or 200, and the transaction associated with the sale information or purchase information is completed, the transaction server 300 may be provided to transmit transaction information thereof to a terminal of the purchaser or seller.

In addition, when the sale information or purchase information is registered through the first or second terminal 100 or 200, and the transaction associated with the sale information or purchase information is completed, the transaction server 300 may be provided to transmit the transaction information thereof to an email of the purchaser or seller's email.

In addition, when the sale information or purchase information is registered through the first or second terminal 100 or 200, and the transaction associated with the sale information or purchase information is completed, the transaction server 300 may be provided to transmit transaction information thereof to the payment system.

More specifically, the transaction server 300 includes a transaction unit 340 that is provided to purchase or buy the flight checked baggage capacity or quantity of the second weight W2 or points corresponding thereto and a flight checked baggage capacity or quantity of a weight exceeding the third weight W3 or a required weight W4 or points corresponding thereto, on the basis of the entered sale information and the purchase information.

Here, the registration unit 320 and the transaction unit 340 are interlinked with each other, so that the sales and purchase information registered at the registration unit 320 may be automatically transmitted to the transaction unit 340.

In addition, as the flight checked baggage capacity or quantity or points corresponding thereto of the seller and purchaser who has completed the transaction at the transaction unit 340 is changed, the transaction server 300 may include a transmission unit 350 for transmitting the changing result to a terminal or via an e-mail.

Therefore, the changed flight checked baggage capacity or quantity or points corresponding thereto which is transmitted from the transmission unit 350 may be used for authentication purpose, upon sending the flight checked baggage at the airport through a terminal, a printed e-mail content or various codes.

In particular, since the completed transaction and the like may be automatically associated with the airline, it is possible to send the baggage by the changed flight check baggage capacity or quantity or points corresponding thereto without undergoing separate authentication and the like.

In addition, the flight checked baggage transaction system of the above configuration may be produced in an application, thereby making it possible to be used more easily and quickly.

A transaction process using the flight checked baggage transaction system 10 described as above will be described hereinafter.

According to a first embodiment, in the case that the seller 101 and the purchaser 201 each is one person, and the seller 101 registers sale information at the transaction server 300, when the seller 101 registers sale information of the flight checked baggage capacity or quantity of the second weight W2 or points corresponding thereto at the transaction server 300 through the registration unit 320, the transaction server 300 transmits the information registered at the registration unit 320 to the transaction unit 340.

Here, the sale amount per flight checked baggage sales capacity (Kg) may be automatically set when registering the sale information, but is not limited thereto.

Accordingly, the purchaser may purchase at least some of a flight checked baggage capacity or quantity of the second weight W2 or points corresponding thereto through the transaction unit 340, as a predetermined amount.

Herein, when the purchaser 201 authenticates the ticket in advance through the authentication unit 310, the seller may notify the sale information through the notification unit 330 when registering the sale information at the registration unit 320, thereby making the transaction more efficient.

On the contrary, according to the second embodiment, in the case that the seller 101 and the purchaser 201 each are one person, and the purchaser 201 registers the purchase information at the transaction server 300, when the purchaser 201 registers purchase information of the flight checked baggage capacity of a weight exceeding the third weight or a required weight W4 at the transaction server 300 through the registration unit 320, the transaction server 300 transmits the information registered at the registration unit 320 to the transaction unit 340.

Herein, the purchase amount for the flight checked baggage purchase capacity (Kg) may be automatically set when registering the purchase information, but is not limited thereto.

Thus, the seller 201 may sell, to the purchaser, at least some of the flight checked baggage capacity or quantity of the second weight W2 or points corresponding thereto through the transaction unit 340.

Herein, when the seller 101 authenticates the ticket in advance through the authentication unit 310, the purchaser may notify the purchase information through the notification unit 330 when registering the purchase information at the registration unit 320, thereby making the transaction more efficient.

According to a third embodiment, in the case that there is one seller 101, and there are two purchasers 201 (hereinafter referred to as a first purchaser and a second purchaser), the seller 101 registers the sale information at the transaction server 300 in order to sell the flight checked baggage capacity or quantity of the second weight W2 smaller than the first weight or points corresponding thereto.

Herein, the sales amount for the flight checked baggage sales capacity (Kg) may be automatically set when registering the sale information, but is not limited thereto.

On the basis of the sale information registered as described above, each of the first purchaser and the second purchaser may enter the flight checked baggage purchase capacity or quantity or corresponding points thereto to be purchased and the amount that is equal to or more than a predetermined sale amount into the transaction unit 340 for transmission.

Herein, the final amount entered into the transaction unit 340 is the value obtained by multiplying the flight checked baggage capacity or quantity or points corresponding thereto by a predetermined sale amount (Won) per capacity (Kg), which is a predetermined amount payed by the final purchaser.

In other words, the purchaser who enters the larger final amount of the first purchaser and the second purchaser may finally purchase the flight checked baggage capacity.

For example, when the seller 101 registers a flight checked baggage capacity or quantity of 10 Kg to be sold or points corresponding thereto at the transaction server 300 through the first terminal 100, each of the first purchaser and the second purchaser enters a flight checked baggage purchase capacity or quantity or points corresponding thereto to purchase and an purchase amount, into the transaction unit 340 for transmission.

Here, when the sale amount per a predetermined capacity is 10,000 won; the first purchaser enters a purchase capacity or quantity of 9 kg or points corresponding thereto and 11,000 won as the purchase amount per the capacity or quantity or points corresponding thereto; and the second purchaser enters a purchase capacity or quantity of 10 kg or points corresponding thereto and 11,000 won as a purchase amount per the capacity or quantity or points corresponding thereto, the first purchaser with a large final amount may be the final purchaser.

In particular, the first purchaser with a large final amount as described above may be the final purchaser, and otherwise, the seller may select the purchaser by comparing the purchase amount per the capacity or quantity of each of the first and second purchasers or points corresponding thereto with the purchase capacity or quantity or points corresponding thereto.

As a result, there is an effect that the seller can sell the flight checked baggage capacity or quantity or points corresponding thereto for a larger amount.

Here, the purchaser may purchase a capacity or quantity or points corresponding thereto that is smaller than the flight checked baggage capacity or quantity of the second weight or points corresponding thereto which is sold by the seller. For example, when a seller sells the capacity of 10 Kg and the purchaser purchases the capacity of 8 Kg, the remaining 2 Kg of flight baggage capacity or quantity of the seller or points corresponding thereto may be sold to another purchaser at transaction server 300.

Conversely, according to a fourth embodiment, when there is one purchaser, and there are two sellers hereinafter, referred to as a first seller and a second seller), the purchaser registers the purchase information at the transaction server 300, in order to purchase a flight checked baggage capacity or quantity of a weight exceeding a third weight or a required weight W4 or points corresponding thereto.

Herein, the purchase amount for the flight checked baggage sales capacity (Kg) may be automatically set when registering purchase information, but is not limited thereto.

On the basis of the purchase information registered as described above, the first seller and the second seller may enter the flight checked baggage capacity or quantity or points corresponding thereto to be sold, and an amount less than or equal to a predetermined sale amount into the transaction unit 340 for transmission.

Herein, the final amount entered into the transaction unit 340 is obtained by multiplying the flight checked baggage purchase capacity or quantity or points corresponding thereto by the purchase amount (Won) set per a capacity (Kg), which is a predetermined amount paid by the final purchaser.

In other words, the seller who sent the smaller final amount of the first seller and the second seller may finally sell the flight checked baggage capacity or quantity or points corresponding thereto.

As such, there is an effect that the purchaser may purchase an additional flight checked baggage capacity or quantity or points corresponding thereto at a lower amount.

For example, when a purchaser registers a flight checked baggage capacity or quantity of 10 Kg or points corresponding thereto at a transaction server 300 through a second terminal 200, each of the first seller and the second seller enters the flight checked baggage sales capacity or quantity or points corresponding thereto to be sold and a sale amount at the transaction unit 340 for transmission.

Here, when the predetermined purchase amount is 10,000 won; the first seller enters the sales capacity or quantity of 10 Kg or points corresponding thereto and 9,000 won; and the second seller enters the sales capacity or quantity of 10 Kg or points corresponding thereto and 8,000 won, the second seller with a small final amount may be the final seller.

Here, the seller may sell a capacity or quantity or points corresponding thereto, which is smaller than the flight checked baggage capacity or quantity of a weight exceeding the third weight or a required weight W4 or points corresponding thereto.

As an example, when the purchaser wants to purchase a capacity or quantity of 10 Kg or points corresponding thereto, and the seller sells a capacity or quantity of 8 Kg or points corresponding thereto, the purchaser may additionally purchase 2 Kg of the insufficient or required capacity or quantity to purchase or points corresponding thereto from another seller at the transaction server 300.

As described above, according to the third and fourth embodiments, like the first and second embodiments, in the case that the seller 101 or the purchaser 201 authenticates the ticket in advance through the authentication unit 310, the notification unit 330 may notify the sale or purchase information when the seller 101 or the purchaser 201 registers the sale or purchase information at the registration unit 320, thereby making the transaction more efficient.

Meanwhile, the transaction server 300 of the present invention may be provided to pay a predetermined fee for one selected from cash, securities, and cryptocurrency to the airline, in order for the seller to register the sale information.

In addition, transaction server 300 may be provided to pay a predetermined fee for one selected from cash, securities, and cryptocurrency to the airline, in order for a purchaser to register purchase information.

In addition, the transaction server 300 may be provided to pay a predetermined fee for one selected from cash, securities, and cryptocurrency to the airline, when the purchaser or seller registers the purchase and sale information and then the corresponding transaction is complete.

In addition, the transaction server 300 may be provided so that the purchaser or seller may watch a predetermined type of video, screen, or phrase on the transaction server in order to complete the transaction after registering the purchase and sale information.

The present invention also relates to a transaction method of transacting a flight checked baggage using a flight checked baggage transaction system 10.

For example, the transaction method relates to a method of transacting the flight checked baggage using the flight checked baggage transaction system described above. Therefore, the details of the method of transacting the flight checked baggage described below may be equally applied to contents described in the flight checked baggage transaction system.

The transaction method using the flight checked baggage transaction system according to the present invention includes registering sale information for selling a flight checked baggage capacity or quantity of a second weight or points corresponding thereto less than the first weight through a first terminal, at a transaction server in which sale information and purchase information are registered, on the basis of the ticket for which the flight checked baggage is permitted up to the first weight.

Also, on the basis of the ticket to which flight checked baggage is allowed up to the third weight, the transaction method includes registering purchase information for purchasing a flight checked baggage capacity or quantity of a weight exceeding the third weight or a required weight or points corresponding thereto through the second terminal.

In addition, the transaction method includes deducting a predetermined fee for one selected from cash, securities, and cryptocurrency through the trading system, when the seller and the purchaser completes a transaction for a capacity or quantity or points corresponding thereto.

In addition, the transaction method includes paying a predetermined fee for one selected from cash, securities, and cryptocurrency to the transaction server, in order for the seller to register the sale information.

In addition, the transaction method includes paying a predetermined fee for one selected from cash, securities, and cryptocurrency to the transaction server, in order for the purchaser to register the purchase information.

In addition, the transaction method includes paying a predetermined fee for one selected from cash, securities, and cryptocurrency to the airline, in order for the seller to register the sale information.

In addition, the transaction method includes paying a predetermined fee for one selected from cash, securities, and cryptocurrency to the airline, in order for the purchaser to register the purchase information.

In addition, the transaction method includes watching a predetermined type of video, screen or phrase on the transaction server, in order for the seller to register the sale information.

In addition, the transaction method includes watching a predetermined type of video, screen or phrase on the transaction server, in order for the purchaser to register the purchase information.

In addition, when the purchaser or seller registers the purchase information or sale information to complete the transaction, the transaction method includes paying a predetermined fee for one selected from cash, securities, and cryptocurrencies to the airline.

In addition, the transaction method includes watching a predetermined type of video, screen, or phrase on the transaction server, when the purchaser or seller registers the purchase and sale information to complete the transaction.

Therefore, there is a further effect that it is possible to obtain additional effects, such as advertising effects by watching a predetermined type of video, screen, or phrase of the seller or purchaser on the transaction server.

1. A flight checked baggage transaction system, comprising:
on the basis of a ticket for which a flight checked baggage is allowed up to a first weight, a first terminal registering sale information for selling a flight checked baggage capacity or quantity of a second weight or points corresponding thereto less than the first weight;
on the basis of a ticket for which a flight checked baggage is allowed up to a third weight, a second terminal registering purchase information for purchasing a flight checked baggage capacity or quantity of a weight exceeding the third weight or a required weight or points corresponding thereto; and
a transaction server in which the sale information and the purchase information are registered.

2. The system of claim 1, wherein each of the first weight and the third weight is a maximum flight checked baggage allowance or corresponding points thereto that is related to a takeoff and landing weight and an allowed cabin load (ACL) for each corresponding aircraft.

3. The system of claim 2, wherein the second weight is a remaining capacity or quantity or points corresponding thereto, which is obtained by subtracting the flight checked baggage capacity or quantity to be used by a seller or points corresponding thereto from the first weight.

4. The system of claim 1, wherein the transaction server further includes an authentication unit provided to authenticate the ticket before registering the sale information and the purchase information.

5. The system of claim 1, wherein the ticket includes a departure date and a departure time, and a seller registers the flight checked baggage capacity or quantity of the second weight or points corresponding thereto at the transaction server via the first terminal, at least prior to check-in/boarding.

6. The system of claim 1, wherein a purchaser purchases at least a portion of the flight checked baggage capacity or quantity of the second weight registered at the transaction server or points corresponding thereto as a predetermined reward, through the second terminal.

7. The system of claim 1, wherein all or at least some of the flight checked baggage capacity or quantity of the second weight or points corresponding thereto, which is registered at the transaction server, are sold by an auction method.

8. The system of claim 1, wherein when the sale information is registered at the transaction server, the purchase server is configured to purchase the flight checked baggage capacity or quantity of the second weight or points corresponding thereto through a plurality of second terminals in an auction method.

9. The system of claim 1, wherein when the purchase information is registered at the transaction server, the transaction server is configured to sell a flight checked baggage capacity or quantity of a weight exceeding the third weight or a required weight or points corresponding thereto through a plurality of first terminals in an auction manner.

10. The system of claim 1, wherein when the sale information is registered in the transaction server, the transaction server is configured so that the flight checked baggage capacity or quantity of a weight exceeding a third weight or a required weight or points corresponding thereto is purchased through a plurality of second terminals in an auction method.

11. The system of claim 1, wherein when the sale information or the purchase information is registered through the first terminal or the second terminal, and transaction related to the sale information or the purchase information is completed, the transaction server is provided to notify an airline of information on the transaction.

12. The system of claim 1, wherein the transaction server further includes a transaction unit provided to purchase and sell a flight checked baggage capacity or quantity of the second weight or points corresponding thereto and a flight checked baggage capacity or quantity of a weight exceeding the third weight or a required weight or points corresponding thereto, on the basis of the sale information and the purchase information entered.

13. A transaction method of flight checked baggage transaction system according to claim 1, the method comprising:
at a transaction server in which sale information and purchase information are registered,
on the basis of a ticket for which a flight checked baggage is allowed up to a first weight, registering the sale information for selling a flight checked baggage capacity or quantity of a second weight less than the first weight or points corresponding thereto through a first terminal; and
on the basis of the tickets for which a flight checked baggage is allowed up to a third weight, registering the purchase information for purchasing a flight checked baggage capacity or quantity or points corresponding thereto of a weight exceeding the third weight or a required weight through a second terminal.

14. The method of claim 13, further comprising:
deducting a predetermined fee for one selected from cash, securities, and cryptocurrency, when the seller and the purchaser complete transaction of capacity or quantity or points corresponding thereto through the transaction system.

15. The method of claim 13, further comprising:
by the seller, paying a predetermined fee for one selected from cash, securities, and cryptocurrencies to the transaction server, in order to register the sale information.

16. The method of claim 13, further comprising:
by the purchaser, paying a predetermined fee for one selected from cash, securities, and cryptocurrencies to the transaction server, in order to register the purchase information.

17. The method of claim 13, further comprising:
by the seller, paying a predetermined fee for one selected from cash, securities, and cryptocurrencies to an airline, in order to register the sale information.

18. The method of claim 13, further comprising:
by the purchaser, paying a predetermined fee for one selected from cash, securities, and cryptocurrencies to an airline, in order to register the purchase information.

19. The method of claim 13, further comprising:
by the seller, watching a predetermined type of video, screen, or phrase on the transaction server, in order to register the sale information.

20. The method of claim 13, further comprising:
by the purchaser or the seller, paying a predetermined fee for one selected from cash, securities, and cryptocurrency to an airline, when the transaction is completed after registering the purchase information or the sale information.
